(19) United States
(12) Patent Application Publication
(10) Pub. No.: US 2018/0019520 A1
(43) Pub. Date: Jan. 18, 2018

(54) SPACE DEPLOYABLE INFLATABLE ANTENNA APPARATUS AND ASSOCIATED METHODS

(71) Applicant: HARRIS CORPORATION, Melbourne, FL (US)

(72) Inventors: Robert C. Hildebrand, Melbourne, FL (US); William C. Adams, West Melbourne, FL (US)

(21) Appl. No.: 15/210,118

(22) Filed: Jul. 14, 2016

(51) Int. Cl. H01Q 15/16; H01Q 3/04; H01Q 1/28; H01Q 9/22; H01Q 1/08

(52) U.S. Cl. CPC H01Q 15/163; H01Q 9/22; H01Q 1/081; H01Q 1/288; H01Q 3/04

(57) ABSTRACT

A space deployable antenna apparatus includes an inflatable antenna configurable between a deflated storage position and an inflated deployed position. The inflatable antenna includes collapsible tubular elements coupled together in fluid communication. The collapsible tubular elements in the deployed position include a longitudinally extending boom tubular element, at least one driven tubular conductive element transverse to the boom tubular element, at least one reflector tubular conductive element transverse to the boom tubular element, and at least one director tubular conductive element transverse to the boom tubular element. A foam dispenser is configured to inject a solidifiable foam into the inflatable antenna to configure to the inflated deployed position.

### FIELD OF THE INVENTION

The present invention relates to the field of antennas, and more particularly, to an inflatable antenna for a spacecraft and related methods.

### BACKGROUND

Deployable antennas are highly desirable in satellite and other space applications. In such applications, it is important for an antenna to be able to fit into a small space, but also be expandable to a fully operational size once orbit has been achieved.

The issue of antenna deployability is especially critical as the size of satellites get smaller. While the sensors and operating electronics of miniaturized satellites can be scaled to extremely small volumes, the wavelengths of the signals used by such miniaturized satellites to communicate do not scale accordingly. Given that the wavelength of a signal determines the size of an antenna used to communicate that signal, antennas for miniaturized satellites still have dimensions similar to those of larger satellites.

One approach for a space deployable antenna is disclosed in U.S. Pat. No. 6,791,510 where the antenna includes an inflatable structure, a plane antenna supported by the inflatable structure and a plurality of tensioning cables for supporting the plane antenna with the inflatable structure. When the antenna is initially placed in a satellite that is to be launched, the plane antenna and the inflatable structure are both stored inside a rocket fairing in their rolled or folded states. After the rocket is launched and the antenna is set on its satellite orbit, a gas or a urethane foam is filled into the inflatable structure to deploy the inflatable structure to its shape. The plane antenna, which is in the rolled or folded state, is extended and the tensioning cables pull uniformly on the membrane surface periphery of the plane antenna to extend it into a flat plane without distortions.

Yet another approach for an inflatable antenna is disclosed in U.S. published patent application no. 2014/0028532. The inflatable antenna includes an inflatable dish with a RF reflective main reflector and an opposing RF transparent dish wall. An inflatable RF transparent support member and an RF reflective subreflector extend from the dish wall. When the antenna is inflated, the main reflector and the subreflector oppose each other to reflect RF energy toward each other to form an antenna. A gas or a hardening foam may be used to fill the inflatable antenna.

Even in view of the above described inflatable antennas, there is still a need to reduce the weight of such antennas. For example, the cost/pound to launch a satellite in a low earth orbit (LEO) is about $10,000, whereas the cost/pound for a synchronous orbit is about $20,000. Consequently, any reduction in weight for a spaced based antenna may result in significant cost savings.

### SUMMARY

In view of the foregoing background, it is therefore an object of the present invention to provide a lightweight inflatable antenna for a spacecraft.

This and other objects, features, and advantages in accordance with the present invention are provided by a space deployable antenna apparatus comprising an inflatable antenna configurable between a deflated storage position and an inflated deployed position and comprising a plurality of collapsible tubular elements coupled together in fluid communication. The plurality of collapsible tubular elements in the deployed position may comprise a longitudinally extending boom tubular element, at least one driven tubular conductive element transverse to said boom tubular element, at least one reflector tubular conductive element transverse to said boom tubular element, and at least one director tubular conductive element transverse to said boom tubular element. A foam dispenser may be configured to inject a solidifiable foam into the inflatable antenna to configure to the inflated deployed position.

An advantage of the foam filled inflatable antenna is that it is light weight as well as low cost. In addition, the inflatable antenna in the inflated deployed position is not impacted by rigid dimensional requirements.

The at least one driven tubular conductive element may comprise a dielectric tube and a pair of spaced apart conductive layers thereon, with each conductive layer having an antenna feed point. The space deployable antenna apparatus may further comprise a coaxial cable having inner and outer conductors coupled to respective ones of the antenna feed points.

The at least one reflector tubular conductive element may comprise a dielectric tube and a conductive layer thereon. Similarly, the at least one director tubular conductive element may comprise a dielectric tube and a conductive layer thereon.

The at least one driven tubular conductive element, the at least one reflector tubular conductive element and the at least one director tubular conductive element may be coplanar with each other when the inflatable antenna is in the deployed position.

The foam dispenser may comprise first and second foam component supplies. The space deployable antenna apparatus may further comprise a mixing valve coupled between the first and second foam component supplies and the inflatable antenna.

The plurality of collapsible tubular elements may comprise a biaxially-oriented polyethylene terephthalate (BoPET) film or a polyimide film, for example.

Another aspect is directed to a spacecraft comprising a transceiver, and a space deployable antenna apparatus coupled to the transceiver, as described above.

Yet another aspect is directed to a method for deploying an inflatable antenna in space. The method may comprise initially storing the inflatable antenna in a deflated storage position within the spacecraft. When in space, a solidifiable foam may be injected from the foam dispenser into the inflatable antenna to configure to an inflated deployed position, with the plurality of collapsible tubular elements being coupled together in fluid communication in the deployed position. The tubular elements may comprise a longitudinally extending boom tubular element, at least one driven tubular conductive element transverse to the boom tubular element, at least one reflector tubular conductive element transverse to the boom tubular element, and at least one director tubular conductive element transverse to the boom tubular element.

### BRIEF DESCRIPTION OF THE DRAWINGS

FIG. 1 is a block diagram of a spacecraft with an inflatable antenna in accordance with the present invention.

FIG. 2 is a block diagram of the inflatable antenna illustrated in FIG. 1 in a deflated storage position.

FIG. 3 is a block diagram of the inflatable antenna illustrated in FIG. 1 in an inflated deployed position.

FIG. 4 is a cross-sectional view of a driven tubular conductive element when the inflatable antenna is in the inflated deployed position, as illustrated in FIG. 3.

FIG. 5 is a cross-sectional view of a reflector tubular conductive element when the inflatable antenna is in the inflated deployed position, as illustrated in FIG. 3.

FIG. 6 is a cross-sectional view of a director tubular conductive element when the inflatable antenna is in the inflated deployed position, as illustrated in FIG. 3.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

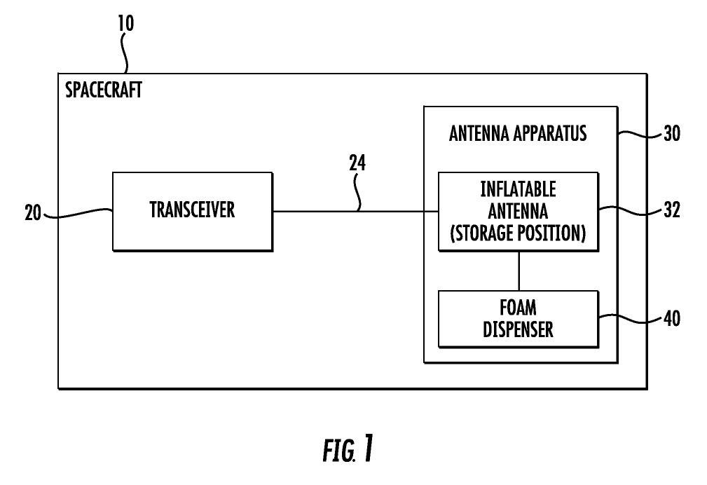

Referring initially to FIG. 1, a spacecraft 10 includes a transceiver 20, and a space deployable antenna apparatus 30 coupled to the transceiver via a coaxial cable 24. The space deployable antenna apparatus 30 includes an inflatable antenna 32 configurable between a deflated storage position and an inflated deployed position. A foam dispenser 40 is configured to inject a solidifiable foam into the inflatable antenna 32 to configure from the deflated storage position to the inflated deployed position.

In the deflated storage position, the inflatable antenna 32 is rolled or folded up as illustrated in FIG. 2. In order to provide the smallest footprint as possible for launch of the spacecraft 10, the inflatable antenna 32 may initially be collapsed in a vacuum and then rolled up.

For the foam dispenser 40, a two-part foam may be used. In the illustrated embodiment, the foam dispenser 40 includes a first foam component supply 42 and a second foam component supply 44. A mixing valve 46 is coupled between the foam dispenser 40 and the inflatable antenna 32. The mixing valve 46 is used to mix together the contents of the first and second foam component supplies 42, 44.

The first and second foam component supplies 42, 44 may include different organic silicons, such as organopolyhydroxy siloxane and organopolyhydrogen siloxane, for example. In addition, one of the organic silicons has a catalyst mixed therein. The catalyst may be platinum, aminoxy or organic tin, for example. When the different organic silicons and the catalyst are mixed together in the mixing valve 46, a chemical reaction occurs. The chemical reaction generates hydrogen bubbles which causes the liquid silicon foam to expand.

When the foam dispenser 40 is activated, the contents of the first and second foam component supplies 42, 44 may be pushed by plungers into the mixing valve 46. Depending on the size of the inflatable antenna 32, it may take about 3 to 5 minutes to fill with the liquid foam. Depending on the temperature, it may take about 45 to 60 minutes for the liquid foam to solidify.

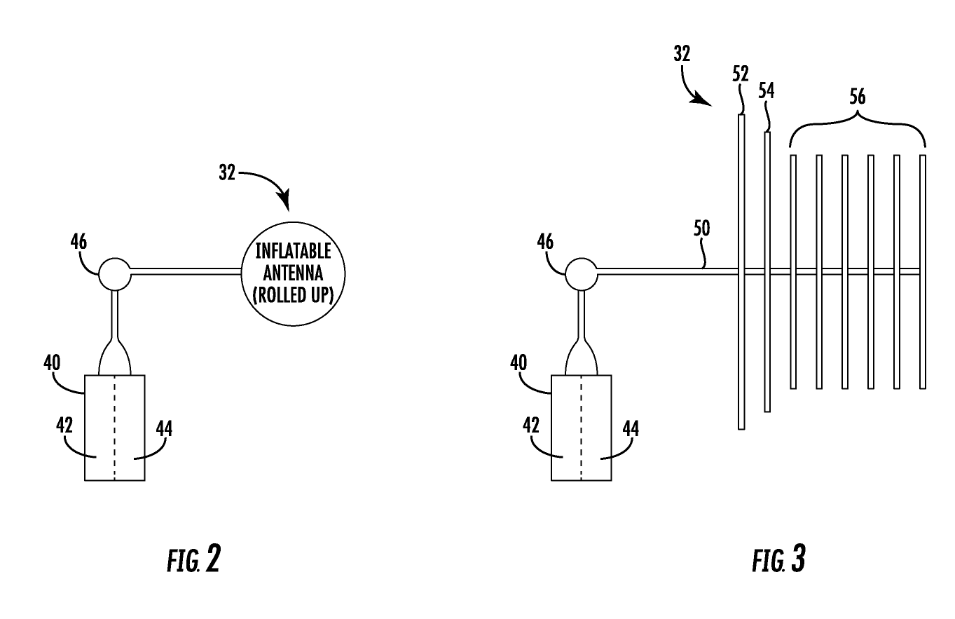

As the liquid foam expands, the inflatable antenna 32 begins to roll out and expand to the inflated deployed position. As illustrated in FIG. 3, the inflatable antenna 32 is configured as a Yagi-Uda antenna.

An advantage of the foam filled inflatable antenna 32 is that it is light weight as well as low cost. In addition, the inflatable antenna 32 in the inflated deployed position is not impacted by rigid dimensional requirements.

More particularly, the inflatable antenna 32 comprises a plurality of collapsible tubular elements coupled together in fluid communication. The collapsible tubular elements in the deployed position comprise a longitudinally extending boom tubular element 50, at least one driven tubular conductive element 54 transverse to the boom tubular element, at least one reflector tubular conductive element 52 transverse to the boom tubular element, and at least one director tubular conductive element 56 transverse to the boom tubular element.

In the illustrated embodiment there are 6 director tubular conductive elements 56. As the number of conductive elements 56 increases, so does the gain of the Yagi-Uda antenna. TABLE 1 provides an approximate gain based on the number of director tubular conductive elements 56. The actual number of director tubular conductive elements 56 will vary depending on the intended application.

TABLE 1
APPROXIMATE YAGI-UDA GAIN LEVELS

| | APPROX ANTICIPATED GAIN DB |
|---|---|
| NUMBER OF ELEMENTS | OVER DIPOLE |
| 2 | 5 |
| 3 | 7.5 |
| 4 | 8.5 |
| 5 | 9.5 |
| 6 | 10.5 |
| 7 | 11.5 |

The inflatable antenna 32 is not limited to any particular frequency. The frequency depends on the intended application of the transceiver 20. As an example, the inflatable antenna 32 may be sized to operate at 450 MHz. At this frequency, the longitudinally extending boom tubular element 50 is about 5 feet in length and the reflector tubular conductive element 52 is about 13 inches in length. The length of the driven tubular conductive element 54 is about 12 inches, and the length of the director tubular conductive elements 56 is about 11 inches. A height and width of the boom tubular element 50 and the respective tubular conductive elements 52, 54, 56 are about 0.5 inches and 0.75 inches, respectively.

The inflatable antenna 32 may be formed out of two dielectric films or layers, where each dielectric layer has an outline corresponding to the Yagi-Uda antenna shape, as illustrated in FIG. 3. The two dielectric layers are joined together to form a dielectric tube with only one open end. The one open end is to receive the liquid silicon foam. The two dielectric layers may be welded together, for example. The dielectric layers are about 1 to 3 mils thick, for example.

At least one of the dielectric layers has a plurality of conductive layers thereon. The conductive layers may be aluminum, copper or gold, for example. The conductive layers may be laminated, printed on, or applied with an adhesive onto the dielectric layer, as readily appreciated by those skilled in the art.

Referring now to FIG. 4, the driven tubular conductive element 54 comprises a dielectric tube 60 and a pair of spaced apart conductive layers 62, 64 thereon, with each conductive layer having an antenna feed point 63, 65. A coaxial cable 24 has inner and outer conductors 26, 28 coupled to respective ones of the antenna feed points 63, 65.

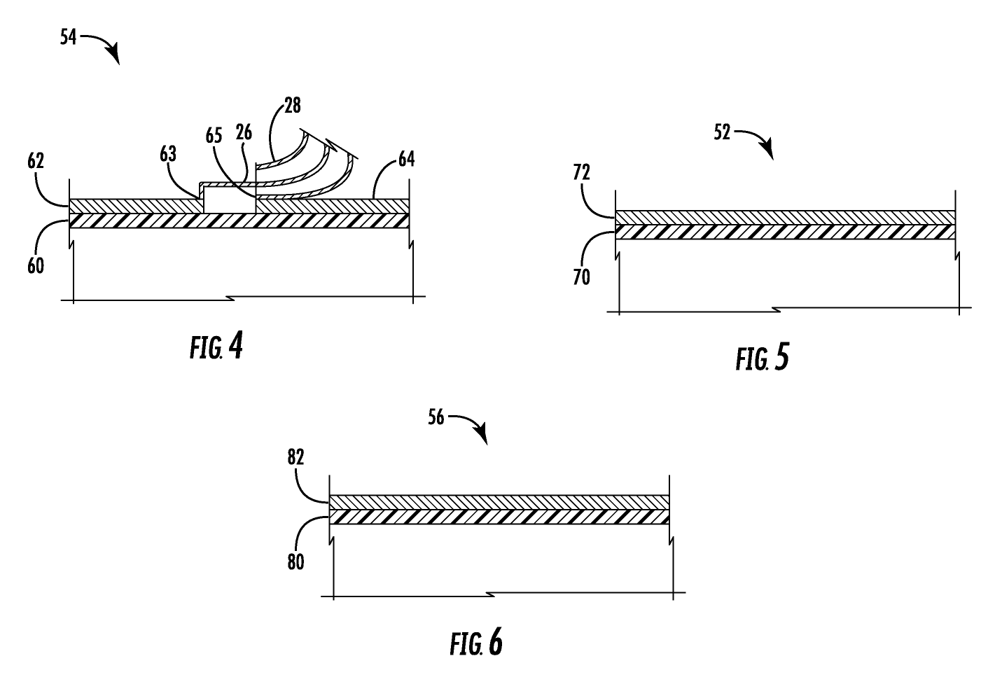

Referring now to FIG. 5, the reflector tubular conductive element 52 comprises a dielectric tube 70 and a conductive layer 72 thereon. Similarly, each director tubular conductive element 56 comprises a dielectric tube 80 and a conductive layer 82 thereon, as illustrated in FIG. 6.

When the inflatable antenna 32 is in the deployed position, the driven tubular conductive element 54, the reflector tubular conductive element 52 and the director tubular conductive elements 56 are coplanar with each other.

The dielectric layers of the inflatable antenna 32 may be made out of Mylar™ or Kapton™, for example. Mylar™ is a polyester film, and more particularly, is a biaxially-oriented polyethylene terephthalate (BoPET) film. Kapton™ is a polyimide film and remains stable across a wide range of temperatures, from −269 to +400° C.

Another aspect is directed to a method for deploying an inflatable antenna 32 in space. The method comprises initially storing the inflatable antenna 32 in a deflated storage position within the spacecraft 10. When in space, a solidifiable foam is injected from the foam dispenser 40 into the inflatable antenna 32 to configure to an inflated deployed position, with the plurality of collapsible tubular elements being coupled together in fluid communication in the deployed position. The tubular elements comprise a longitudinally extending boom tubular element 50, at least one driven tubular conductive element 54 transverse to the boom tubular element, at least one reflector tubular conductive element 52 transverse to the boom tubular element, and at least one director tubular conductive element 56 transverse to the boom tubular element.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A space deployable antenna apparatus comprising:
an inflatable antenna configurable between a deflated storage position and an inflated deployed position and comprising a plurality of collapsible tubular elements coupled together in fluid communication, said plurality of collapsible tubular elements in the deployed position comprising
a longitudinally extending boom tubular element,
at least one driven tubular conductive element transverse to said boom tubular element,
at least one reflector tubular conductive element transverse to said boom tubular element, and
at least one director tubular conductive element transverse to said boom tubular element; and
a foam dispenser configured to inject a solidifiable foam into said inflatable antenna to configure to the inflated deployed position.

2. The space deployable antenna apparatus according to claim 1 wherein said at least one driven tubular conductive element comprises a dielectric tube and a pair of spaced apart conductive layers thereon, with each conductive layer having an antenna feed point.

3. The space deployable antenna apparatus according to claim 2 further comprising a coaxial cable having inner and outer conductors coupled to respective ones of the antenna feed points.

4. The space deployable antenna apparatus according to claim 1 wherein said at least one reflector tubular conductive element comprises a dielectric tube and a conductive layer thereon.

5. The space deployable antenna apparatus according to claim 1 wherein said at least one director tubular conductive element comprises a dielectric tube and a conductive layer thereon.

6. The space deployable antenna apparatus according to claim 1 wherein said at least one driven tubular conductive element, said at least one reflector tubular conductive element and said at least one director tubular conductive element are coplanar with each other when said inflatable antenna is in the deployed position.

7. The space deployable antenna apparatus according to claim 1 wherein said foam dispenser comprises first and second foam component supplies.

8. The space deployable antenna apparatus according to claim 7 further comprising a mixing valve coupled between said first and second foam component supplies and said inflatable antenna.

9. The space deployable antenna apparatus according to claim 1 wherein said plurality of collapsible tubular elements comprises a biaxially-oriented polyethylene terephthalate (BoPET) film.

10. The space deployable antenna apparatus according to claim 1 wherein said plurality of collapsible tubular elements comprises a polyimide film.

11. A spacecraft comprising:
a transceiver; and
a space deployable antenna apparatus coupled to said transceiver and comprising
an inflatable antenna configurable between a deflated storage position and an inflated deployed position and comprising a plurality of collapsible tubular elements coupled together in fluid communication, said plurality of collapsible tubular elements in the deployed position comprising
a longitudinally extending boom tubular element,
at least one driven tubular conductive element transverse to said boom tubular element,
at least one reflector tubular conductive element transverse to said boom tubular element, and
at least one director tubular conductive element transverse to said boom tubular element; and
a foam dispenser configured to inject a solidifiable foam into said inflatable antenna to configure to the inflated deployed position.

12. The spacecraft according to claim 11 wherein said at least one driven tubular conductive element comprises a dielectric tube and a pair of spaced apart conductive layers thereon, with each conductive layer having an antenna feed point.

13. The spacecraft according to claim 12 further comprising a coaxial cable coupled between said transceiver and said at least one driven tubular conductive element, with said coaxial cable having inner and outer conductors coupled to respective ones of the antenna feed points.

14. The spacecraft according to claim 11 wherein said at least one reflector tubular conductive element comprises a dielectric tube and a conductive layer thereon.

15. The spacecraft according to claim 11 wherein said at least one director tubular conductive element comprises a dielectric tube and a conductive layer thereon.

16. The spacecraft according to claim 11 wherein said at least one driven tubular conductive element, said at least one reflector tubular conductive element and said at least one director tubular conductive element are coplanar with each other when said inflatable antenna is in the deployed position.

17. The spacecraft according to claim 11 wherein said foam dispenser comprises first and second foam component supplies.

18. The spacecraft according to claim 17 further comprising a mixing valve coupled between said first and second foam component supplies and said inflatable antenna.

19. The spacecraft according to claim 11 wherein said plurality of collapsible tubular elements comprises at least one of a biaxially-oriented polyethylene terephthalate (BoPET) film and a polyimide film.

20. A method for deploying an inflatable antenna in space comprising:
storing the inflatable antenna in a deflated storage position; and
when in space injecting a solidifiable foam from a foam dispenser into the inflatable antenna to configure to an inflated deployed position, with the plurality of collapsible tubular elements being coupled together in fluid communication in the deployed position and comprising
a longitudinally extending boom tubular element,
at least one driven tubular conductive element transverse to the boom tubular element,
at least one reflector tubular conductive element transverse to the boom tubular element, and
at least one director tubular conductive element transverse to the boom tubular element.

21. The method according to claim 20 wherein the at least one driven tubular conductive element comprises a dielectric tube and a pair of spaced apart conductive layers thereon, with each conductive layer having an antenna feed point.

22. The method according to claim 21 further comprising a coaxial cable having inner and outer conductors coupled to respective ones of the antenna feed points.

23. The method according to claim 20 wherein the at least one reflector tubular conductive element comprises a dielectric tube and a conductive layer thereon.

24. The method according to claim 20 wherein the at least one director tubular conductive element comprises a dielectric tube and a conductive layer thereon.

25. The method according to claim 20 wherein said at least one driven tubular conductive element, the at least one reflector tubular conductive element and the at least one director tubular conductive element are coplanar with each other when the inflatable antenna is in the deployed position.

26. The method according to claim 20 wherein the foam dispenser comprises first and second foam component supplies, and further comprising a mixing valve coupled between the first and second foam component supplies and the inflatable antenna.

27. The method according to claim 20 wherein the plurality of collapsible tubular elements comprises at least one of a biaxially-oriented polyethylene terephthalate (BoPET) film and a polyimide film.
